(19) United States
(12) Patent Application Publication
(10) Pub. No.: US 2026/0091549 A1
(43) Pub. Date: Apr. 2, 2026

(54) Screen Protector Application Structure

(71) Applicant: Jinhua Liu, Huizhou City (CN)

(72) Inventors: Jinhua Liu, Huizhou City (CN); Chunlin Jiang, Ji'an City (CN)

(73) Assignee: Jinhua Liu, Huizhou City (CN)

(21) Appl. No.: 19/341,479

(22) Filed: Sep. 26, 2025

(30) Foreign Application Priority Data
Sep. 27, 2024 (CN) 202422361122.5
Jul. 25, 2025 (CN) 202521576929.9
Jul. 25, 2025 (CN) 202521576936.9
Aug. 11, 2025 (CN) 202521708598.X
Aug. 11, 2025 (CN) 202521708617.9

(51) Int. Cl. B29C 63/00; B29L 31/34

(52) U.S. Cl. CPC B29C 63/0004; B29C 2063/0008; B29L 2031/3437

(57) ABSTRACT

A screen protector application structure includes a limiting frame configured to cover a smart terminal, where the limiting frame has a first placement space for placing a release film and a protective film, and a second placement space for placing the smart terminal, a first opening configured for the release film to pass is formed between the first placement space and the second placement space, a first avoidance surface is disposed at the first opening and is configured to allow the release film to be pulled out from the first opening, and a distance between a lowest point of the first avoidance surface and a screen of the smart terminal is smaller than a thickness of the protective film. By optimizing the limiting structure, the present disclosure improves screen protector application accuracy and consistency, and maintains low structural manufacturing cost.

### TECHNICAL FIELD

The present disclosure relates to the field of screen protector application, and in particular to a screen protector application structure.

### BACKGROUND

With the continuous development of the cellphone screen protector market, the screen protector application industry is constantly seeking innovation and breakthroughs. A conventional manual screen protector application method exhibits low efficiency and requires high technical proficiency for operators, thereby becoming difficult to meet large-scale market demands. The emergence of a cellphone screen protector applicator brings new developmental opportunities for the screen protector application industry. The screen protector applicator can enhance screen protector application efficiency and quality, and reduce screen protector application cost, thereby meeting rapidly growing demands for screen protector application services. However, the screen protector applicator in the prior art typically employs a complex structure to achieve a simple screen protector application effect, which significantly increases the manufacturing cost of the screen protector applicator.

### SUMMARY

To overcome the above deficiency, the present disclosure provides a screen protector application structure, including a limiting frame configured to cover a smart terminal, where the limiting frame has a first placement space for placing a release film and a protective film, and a second placement space for placing the smart terminal, a first opening configured for the release film to pass is formed between the first placement space and the second placement space, the limiting frame is provided with a first stopping plate located in the first placement space and configured to abut against the smart terminal, and a second stopping plate located on a side of the first placement space away from the second placement space and configured to stop the protective film from moving away from the smart terminal, a first avoidance surface is disposed at the first opening, the release film is located between the smart terminal and the first avoidance surface, the first avoidance surface is configured to allow the release film to be pulled out from the first opening, and a distance between a lowest point of the first avoidance surface and a screen of the smart terminal is smaller than a thickness of the protective film.

Further, the first placement space is formed by the second stopping plate covering the first stopping plate configured in a rectangular frame shape, and the second stopping plate covers part of the first stopping plate; the second placement space is formed by superimposing the first stopping plate and a stopping sidewall, a sidewall width of the first stopping plate is greater than a unilateral width of the stopping sidewall, and the first stopping plate is exposed by the stopping sidewall; and the first avoidance surface is located on a side of the first opening close to the first stopping plate.

Further, an outer wall of the limiting frame is further provided with a snap fastener including a first snap-fit portion and a second snap-fit portion, and the first snap-fit portion and the second snap-fit portion are disposed at opposite ends or along a periphery of the limiting frame, respectively; the first snap-fit portion has an arc-shaped transition structure, which is inwardly bendable to be fitted with a fillet contour of a rear cover of the smart terminal; and the second snap-fit portion extends toward a bottom port position of the smart terminal and has a recess segment or a tongue segment structure configured for snap-in connection and locking into the bottom port.

Further, an inner side of the limiting frame is provided with avoidance recesses and structural reinforcement ribs.

Further, a pre-positioning structure is disposed between the protective film and the limiting frame, and the pre-positioning structure includes first protruding posts disposed on an inner wall of a front end edge of the limiting frame, and easily removable slots formed at an edge of the release film.

Further, each of the easily removable slots is in communication with an expansion structure, the expansion structure may be a hole, a perforation penetrating an edge of the release film and a pull strip, or a break line; when the expansion structure is configured as a hole structure, each of the first protruding posts is preferably provided with an inclined guide portion, and when the expansion structure is configured as a break line, the expansion structure is a dashed-line structure formed on each of the easily removable slots by a pre-cutting or indentation process; and when a first pull portion is pulled and drawn out from the first opening, the expansion structure is configured to reduce resistance of the easily removable slots separating from the first protruding posts, such that the first pull portion is quickly drawn out through the first opening.

Further, the pre-positioning structure further includes an attachment unit, and the attachment unit is configured to fix the position of the protective film. The attachment unit is a low-adhesion adhesive layer disposed on a surface of the protective film close to the limiting frame.

Further, a pull strip is disposed between the release film and the smart terminal. The pull strip is adhered parallel to the release film, the easily removable slots and the protruding strips are disposed at an edge of the pull strip and/or the release film and configured to form a snap-in connection cooperation with the first protruding posts.

Further, the screen protector application structure further includes a screen protector application box configured to cooperate with the limiting frame, where the screen protector application box has a first housing, a second housing configured to cooperate with the first housing, and a second opening in communication with the first opening, the first housing is configured to bear the limiting frame, and the second housing covers and encloses the smart terminal within the limiting frame; and the release film and/or the pull strip extend/extends out of the limiting frame and the screen protector application box through the first opening and the second opening.

Further, the number of the limiting frames may be two, the two limiting frames are hingedly connected at one end to form a connecting portion, the first opening is disposed at the other end of each of the limiting frames away from the connecting portion, and the two limiting frames are detachably connected by a snap-fit structure.

Compared with the prior art, the present disclosure has the following beneficial effects:
1. Compared to the frame-type screen protector application structure in the prior art, which suffer from deficiencies such as structural looseness, pulling deviation, misalignment during screen protector application, and difficulty in bubble expulsion, the present disclosure, by optimizing the limiting structure and the pulling path design, ensures that the protective film remains in a controllable state throughout the film pulling process, improves screen protector application accuracy and consistency, and maintains low structural manufacturing cost.
2. With the snap fastener added, the present disclosure can effectively prevent misalignment of the entire frame caused during the film pulling process, and ensure controllable and reliable screen protector application effects. The screen protector application structure has significant beneficial effects of a rational structure, low manufacturing cost, simple operation, and strong adaptability.
3. With the screen protector application box added, the present disclosure can prevent impact-induced breakage of the single limiting frame, such that the maintenance cost is reduced, and the reusability is enhanced. Moreover, the design of the above stopping structures in the present disclosure ensures that the protective film can be accurately applied onto the screen of the smart terminal without positioning by using an additional positioning film, which further reduces the manufacturing cost.

Additional aspects and advantages of the present disclosure will be given in the following description, and part of the aspects and advantages will be apparent from the following description, or will be understood through the practice of the present disclosure.

### BRIEF DESCRIPTION OF THE DRAWINGS

In order to explain the technical solutions in embodiments of the present disclosure or in the prior art more clearly, the drawings to be used in the embodiments or the prior art will be briefly introduced below. Obviously, the drawings described below are only some embodiments of the present disclosure. For those of ordinary skill in the art, other drawings may be obtained based on these drawings without making creative efforts.

FIG. 1 is a schematic exploded view of an overall structure of the present disclosure.

FIG. 2 is a schematic structural view of a limiting frame of the present disclosure.

FIG. 3 is a sectional view of a limiting frame of the present disclosure.

FIG. 4 is a partial enlarged view of a portion A in the sectional view of the limiting frame of the present disclosure.

FIG. 5 is a schematic structural view of a limiting frame of the present disclosure in another configuration.

FIG. 6 is a schematic structural view of a snap fastener of the present disclosure.

FIG. 7 is a schematic structural view of a snap fastener of the present disclosure in another configuration.

FIG. 8 is a schematic structural view of a pre-positioning structure of the present disclosure.

FIG. 9 is a schematic structural view of a pre-positioning structure of the present disclosure in another configuration.

FIG. 10 is a use state diagram showing a combination of the screen protector application box and the present disclosure.

FIG. 11 is an overall schematic structural view of a screen protector application box of the present disclosure in another configuration.

FIG. 12 is a structural view of a screen protector application box of the present disclosure in an unfolded state.

Reference numerals in the figures: 200—smart terminal; 100—limiting frame; 300—release film; 400—protective film; 110—first placement space; 120—second placement space; 130—first opening; 140—first stopping plate; 150—second stopping plate; 131—first avoidance surface; 160—stopping sidewall; 170—snap fastener; 171—first snap-fit portion; 172—second snap-fit portion; 173—avoidance recess; 174—rib; 180—first protruding post; 310—easily removable slot; 311—expansion structure; 320—protruding strip; 410—attachment unit; 600—screen protector application box; 610—first housing; 620—second housing; 630—second opening; 190—connecting portion; 500—pull strip; 330—first pull portion; 510—second pull portion; and 640—bearing plate.

### DETAILED DESCRIPTIONS OF THE EMBODIMENTS

The technical solutions in embodiments of the present disclosure will be clearly and completely described below. It is obvious that the described embodiments are only a part of, rather than all of, the embodiments of the present disclosure. Based on the embodiments in the present disclosure, all other embodiments obtained by those of ordinary skill in the art without making creative efforts will fall within the protection scope of the present disclosure.

The present disclosure will be explained in more detail. It should be understood that the specific embodiments described herein are used only for explaining the present disclosure, rather than limiting the present disclosure. It should be noted that when an element is expressed to be “fixed to” another element, it means that the element may be directly on another element, or one or more intervening elements may also be present. When an element is expressed to be “connected” to another element, the element may be directly connected to another element, or one or more intervening elements may also be present.

In the description of the present disclosure, it should be noted that orientations or positional relations indicated by directional terms “front”, “rear”, “upper”, “lower”, “left”, “right”, “transverse”, “vertical”, “perpendicular”, “horizontal”, “top”, and “bottom” are based on orientations or positional relations shown in the drawings and are only for facilitating the description of the present disclosure and simplifying the description, and do not indicate or imply that a device or element involved must have a particular orientation or be constructed and operated in a particular orientation, unless expressly stated otherwise. Therefore, these directional terms should not be construed as a limitation to the protection scope of the present disclosure. Directional terms “inner” and “outer” refer to the interior and exterior relative to contours of respective components themselves. In the description of the present disclosure, it should be noted that terms “first” and “second” are used to define components merely for the purpose of distinguishing between corresponding components. Unless otherwise stated, the terms have no special meanings. Therefore, these terms should not be construed as limiting the protection scope of the present disclosure. In the present disclosure, the term “a plurality of” refers to two or more, unless otherwise specifically defined.

Unless otherwise defined, all technical and scientific terms used in the specification have the same meanings as commonly understood by those skilled in the technical field of the present disclosure. Terms used in the specification of the present disclosure are used only for the purpose of describing specific embodiments, and are not intended to limit the present disclosure.

In addition, the technical features described below and involved in different embodiments of the present disclosure may be combined with each other, as long as there is no conflict.

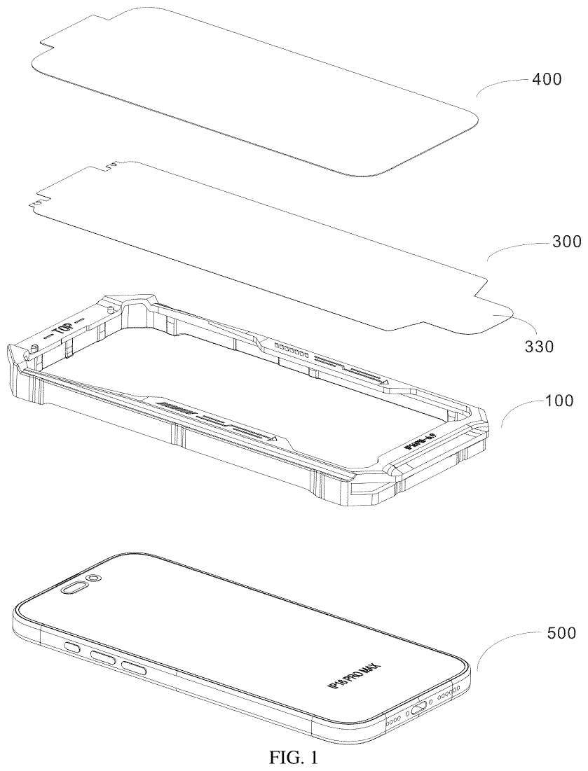

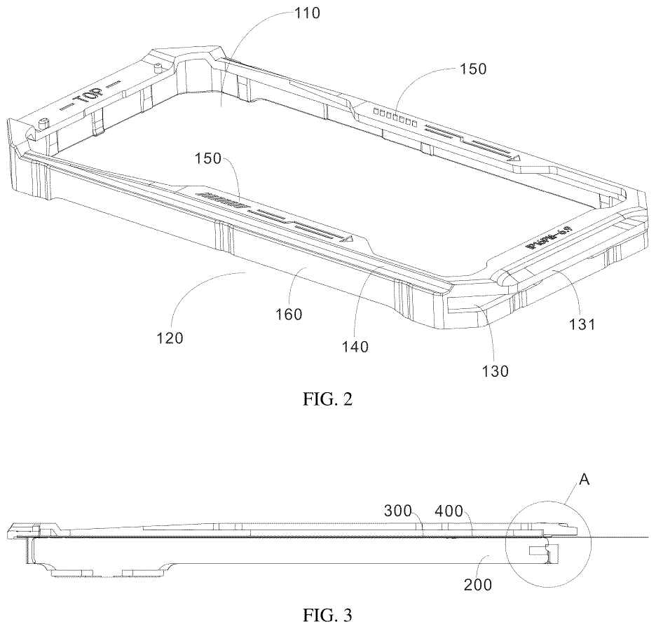

The preferred embodiments of the present disclosure will be further described in combination with the drawing. As shown in FIGS. 1 and 2, a screen protector application structure includes a limiting frame 100 configured to cover a smart terminal 200, where the limiting frame 100 has a first placement space 110 for placing a release film 300 and a protective film 400, and a second placement space 120 for placing the smart terminal 200, a first opening 130 configured for the release film 300 to pass is formed between the first placement space 110 and the second placement space 120, the limiting frame 100 is provided with a first stopping plate 140 located in the first placement space 110 and configured to abut against the smart terminal 200, and a second stopping plate 150 located on a side of the first placement space 110 away from the second placement space 120 and configured to stop the protective film 400 from moving away from the smart terminal 200, a first avoidance surface 131 is disposed at the first opening 130, the release film 300 is located between the smart terminal 200 and the first avoidance surface 131, the first avoidance surface 131 is configured to allow the release film 300 to be pulled out from the first opening 130, and a distance between a lowest point of the first avoidance surface 131 and a screen of the smart terminal 200 is smaller than a thickness of the protective film 400.

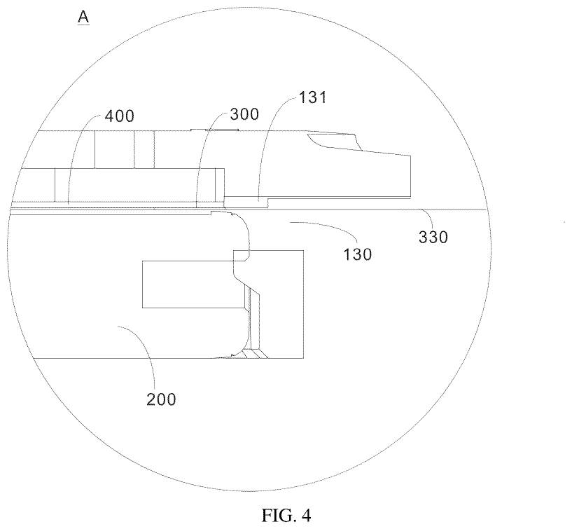

In a specific embodiment of the present disclosure, as shown in FIGS. 2, 3, and 4, the first placement space 110 is formed by the second stopping plate 150 covering the first stopping plate 140 configured in a rectangular frame shape, and the second stopping plate 150 covers part of the first stopping plate 140; the second placement space 120 is formed by superimposing the first stopping plate 140 and a stopping sidewall 160, a sidewall width of the first stopping plate 140 is greater than a unilateral width of the stopping sidewall 160, and the first stopping plate 140 is exposed by the stopping sidewall 160; and the first avoidance surface 131 is located on a side of the first opening 130 close to the first stopping plate 140. The protective film 400 generally refers to a cellphone screen protector attached to the screen of the smart terminal 200, and the release film 300 is attached to an adhesive surface of the protective film 400 and is a flexible film for preventing the adhesive surface of the protective film 400 from being contaminated by dust particles and/or damaged by external scratches. During use, a first pull portion 330 of the release film 300 passes through the first opening 130 to facilitate pull-out of the release film 300 by a user.

In actual use, the user grips the first pull portion 330 to pull out the release film 300, and the second stopping plate 150 stops the protective film 400 from moving away from the smart terminal 200. Since the thickness of the protective film 400 is greater than the distance between the lowest point of the first avoidance surface 131 and the screen of the smart terminal 200, the protective film 400 is prevented from passing through the first opening 130. Moreover, as the second stopping plate 150 stops the protective film 400 from moving away from the screen, the protective film 400 is adhered onto the screen.

It should be noted that the first avoidance surface 131 is in a planar structure. However, in actual use, the first avoidance surface 131 may also be a wavy surface or a concave-convex surface. When the first avoidance surface 131 is a wavy surface, a top end of a wave peak of the wavy surface is the lowest point; and when the first avoidance surface 131 is a concave-convex surface, a top end of a convex surface of the concave-convex surface is the lowest point. Additionally, the limiting frame 100 may be of an integrated structure or a segmented structure, which means that the limiting frame 100 may be divided into two segments or one segment.

During practical operation, it is necessary to first check whether the limiting frame is intact, and ensure that the first placement space 110 and the second placement space 120 are clean and free of debris. The release film 300 and the protective film 400 are placed in the first placement space 110 in a correct direction (the first pull portion 330 is moved toward and passed through the first opening 130, and the protective film 400 is located above the release film 300). The smart terminal 200 is placed in the second placement space 120, with the screen facing the first placement space 110. Then, the release film 300 is slowly pulled out through the first opening 130. In the pulling process, the release film 300 drives the protective film 400 to move gradually away from the screen of the smart terminal 200. At the moment, the user may press the protective film 400 using an external component to keep the protective film 400 closer to the screen and expel air. When the protective film 400 contacts the screen of the smart terminal 200, the protective film 400 begins to adhere to the screen because the distance between the lowest point of the first avoidance surface 131 and the screen is less than the thickness of the protective film 400. The release film 300 is continuously pulled slowly until the protective film 400 is fully adhered to the screen of the smart terminal 200. Finally, the smart terminal 200 with the protective film is taken out from the limiting frame, and the screen protector application process is completed. This low-cost simplified screen protector application structure has the advantages of a simple structure, low manufacturing cost, and easy operation, and provides a convenient screen protector application method for the user.

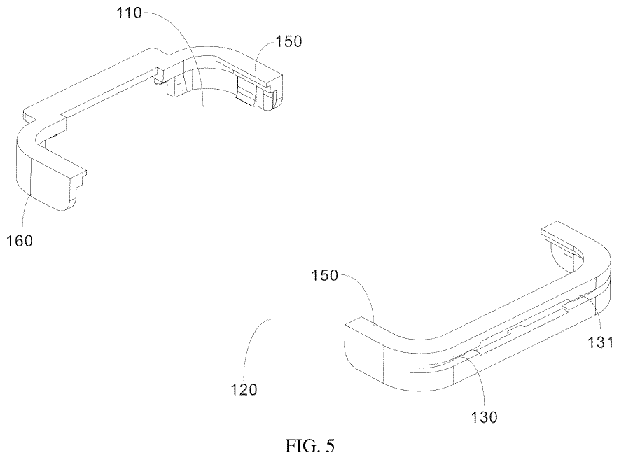

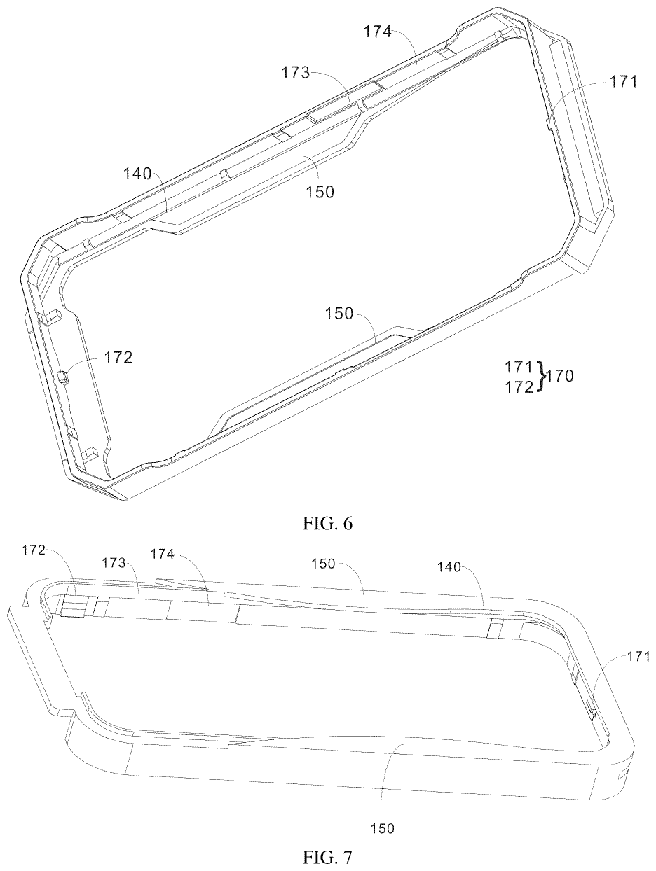

Further, based on the above embodiment, as shown in FIGS. 5 and 6, an outer wall of the limiting frame 100 is further provided with a snap fastener 170 including a first snap-fit portion 171 and a second snap-fit portion 172, and the first snap-fit portion 171 and the second snap-fit portion 172 are disposed at opposite ends or along a periphery of the limiting frame 100, respectively; the first snap-fit portion 171 has an arc-shaped transition structure, which is inwardly bendable to be fitted with a fillet contour of a rear cover of the smart terminal 200; and the second snap-fit portion 172 extends toward a bottom port position of the smart terminal 200 and has a recess segment or a tongue segment structure configured for snap-in connection and locking into the bottom port. The snap fastener 170 automatically abuts against and locks the smart terminal when the frame is sleeved over the smart terminal, thereby effectively preventing the limiting frame 100 from loosening or slipping during operation, and enhancing the overall structural stability. It should be noted that in the above embodiment, only one of the first snap-fit portion 171 and the second snap-fit portion 172 may also be employed, provided that the snap-fit portions used are respectively arranged at opposite ends or along the periphery of the limiting frame 100, so as to achieve the effect of preventing the limiting frame 100 from loosening or slipping during operation.

Further, based on the above embodiment, as shown in FIGS. 5 and 6, an inner side of the limiting frame 100 is provided with avoidance recesses 173 and structural reinforcement ribs 174. The avoidance recesses 173 are configured to place side buttons and volume buttons of the smart terminal 200, and the ribs 174 are configured to enhance the overall longitudinal structural stability of the frame and prevent deformation during the pressing or pulling process.

Further, based on the above embodiment, as shown in FIG. 7, a pre-positioning structure is disposed between the protective film 400 and the limiting frame 100, and the pre-positioning structure includes first protruding posts 180 disposed on an inner wall of a front end edge of the limiting frame 100, and easily removable slots 310 formed at an edge of the release film 300. In this embodiment, the first protruding posts 180 have racetrack-shaped cross-sections, and the easily removable slots 310 may be racetrack-shaped open slots. The opening slots are sleeved over the first protruding posts 180 to form a snap-in connection cooperation, thereby achieving anti-displacement fixation between the release film 300 and the limiting frame 100. In this way, a front end of the release film 300 is temporarily fixed to the front end of the limiting frame 100, while a rear end of the release film 300 remains movable. During actual packaging and transportation, a packaging box is generally required. A bottom of the packaging box can bear movable ends of the release film 300 and the protective film 400 to prevent the front ends from disengaging from the limiting frame 100. Even when only the front end of the release film 300 is temporarily fixed to the limiting frame 100 by a limiting snap-in connection unit, the protective film 400 can be quickly aligned with the screen of the smart terminal 200 when the limiting frame 100 is sleeved over an exterior of the smart terminal 200.

Further, based on the above embodiment, as shown in FIG. 7, to improve the smoothness of assembly and disassembly between the first protruding posts 180 and the easily removable slots 310, each of the easily removable slots 310 is in communication with an expansion structure 311, and the expansion structure may be a hole, a perforation penetrating an edge of the release film 300, or a break line. When the expansion structure 311 is configured as a perforation, an opening width of the perforation is designed to be greater than half a circumference of the cooperating first protruding post 180, thereby achieving both stable fixation and easy pulling functions. When the expansion structure 311 is configured as a hole structure, each of the first protruding posts 180 is preferably provided with an inclined guide portion, and the inclined portion extends toward the direction in which the user pulls the first pull portion 330, thereby facilitating automatic misalignment and disengagement during pulling. Specifically, during actual manufacturing, the expansion structure 311 may also be designed as a break line, and a dashed-line structure is formed on each of the easily removable slots 310 by a pre-cutting or indentation process. When the first pull portion 330 is pulled and drawn out from the first opening 130, the dashed-line structure is configured to reduce the resistance of the easily removable slots 310 separating from the first protruding posts 180, such that the first pull portion 330 can be quickly drawn out through the first opening 130.

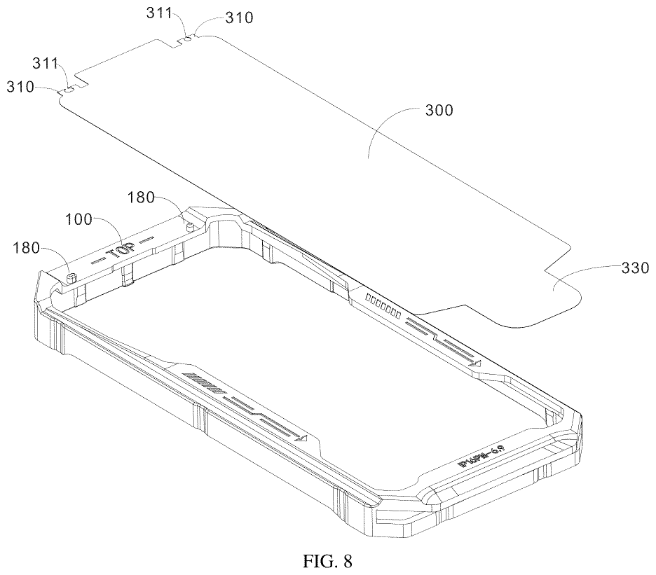

Further, based on the above embodiment, as shown in FIG. 8, the front end of the release film 300 is provided with two protruding strips 320 extending forward; and the number of easily removable slots 310 is two, with one easily removable slot 310 correspondingly disposed on one protruding strip 320. During use, when the easily removable slots 310 are sleeved over the first protruding posts 180, the protective film 400 may be moved by utilizing the bending performance of the protruding strips 320, and the protective film 400 may be moved upward or downward to get close to the screen of the smart terminal 200.

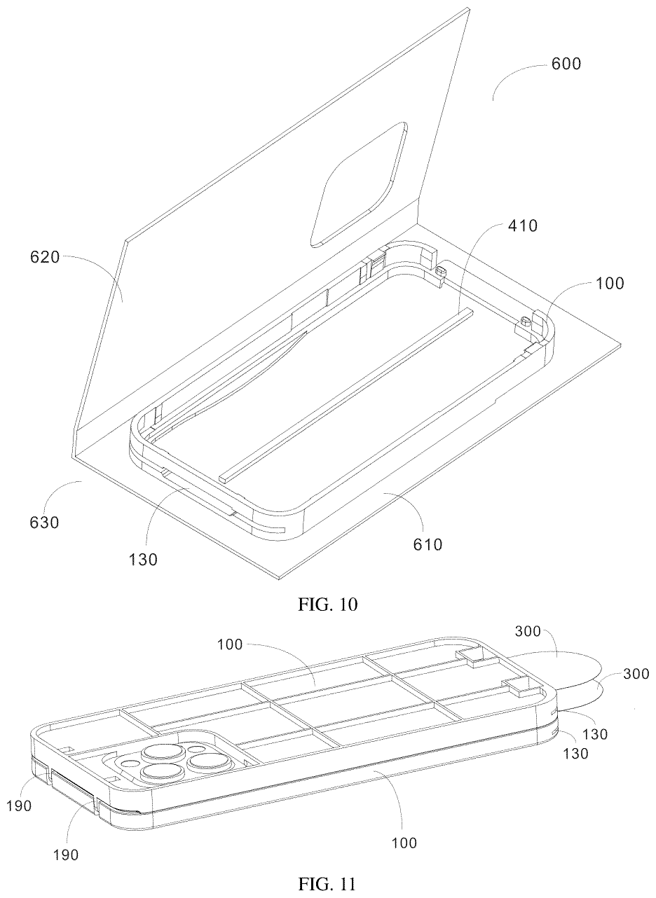

Further, based on the above embodiment, as shown in FIG. 10, the pre-positioning structure further includes an attachment unit 410, and the attachment unit 410 is configured to fix the position of the protective film 400 before screen protector application. The attachment unit 410 is preferably a low-adhesion adhesive layer disposed on a surface of the protective film 400 close to the limiting frame 100. By selecting an appropriate adhesive strength (lower than the pulling force applied by the user to the first pull portion 330), it is ensured that the release film 300 can be smoothly separated during force application, and the adhesive layer itself does not obstruct the screen protector application process.

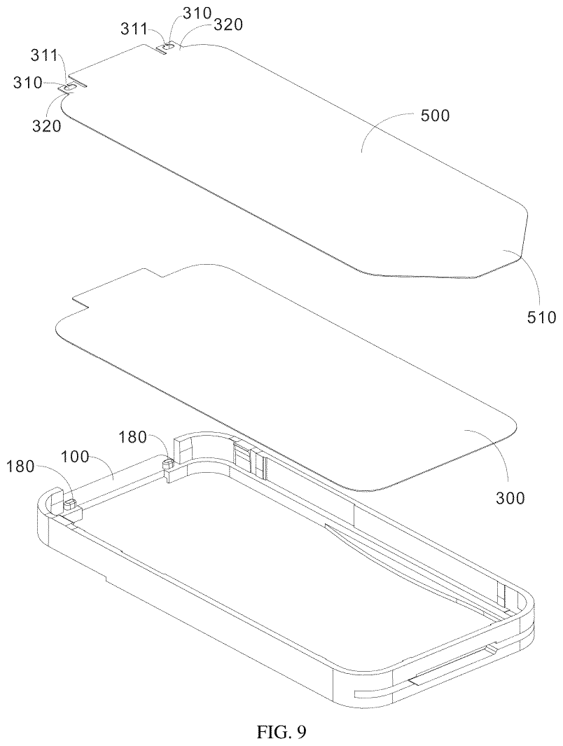

Further, based on the above embodiment, as shown in FIG. 9, a pull strip 500 is disposed between the release film 300 and the smart terminal 200, the pull strip 500 has a second pull portion 510, and the pull strip 500 is adhered parallel to the release film 300. The easily removable slots 310 and the protruding strips 320 are disposed at an edge of the pull strip 500 or the release film 300 (or may simultaneously be disposed at the edge of the release film 300) and configured to form a snap-in connection cooperation with the first protruding posts 180. In this embodiment, the pull strip 500 may replace the release film 300. When the pull strip 500 is fixed to the limiting frame 100, the user grips the second pull portion 510 to pull out the pull strip 500, and the second stopping plate 150 stops the protective film 400 from moving away from the smart terminal 200. Since the thickness of the protective film 400 is greater than the distance between the lowest point of the first avoidance surface 131 and the screen of the smart terminal 200, the protective film 400 is prevented from passing through the first opening 130. Moreover, as the second stopping plate 150 stops the protective film 400 from moving away from the screen, the protective film 400 is adhered onto the screen.

Further, based on the above embodiment, as shown in FIG. 10, the screen protector application structure further includes a screen protector application box 600 configured to cooperate with the limiting frame 100, where the screen protector application box 600 has a first housing 610, a second housing 620 configured to cooperate with the first housing 610, and a second opening 630 in communication with the first opening 130, the first housing 610 is configured to bear the limiting frame 100, and the second housing 620 covers and encloses the smart terminal 200 within the limiting frame 100; and the release film 300 and/or the pull strip 500 extend/extends out of the limiting frame 100 and the screen protector application box 600 through the first opening 130 and the second opening 630. The attachment unit 410 is mounted on the first housing 610 and/or the second housing 620. That is, the attachment unit 410 may be mounted on either one of the first housing 610 and the second housing 620, or may be mounted on both the first housing 610 and the second housing 620 simultaneously.

When the attachment unit 410 is mounted on the first housing 610, in the operation of this embodiment, the screen of the smart terminal 200 faces the first housing 610 (i.e., facing downward), the release film 300 (the pull strip 500 may be included) and the protective film 400 are located between the smart terminal 200 and the attachment unit 410. In this case, the attachment unit 410 functions to fix the position of the protective film 400, and when the user pulls the release film 300 (the pull strip 500 may be included) out of the limiting frame 100 through the first opening 130 and the second opening 630, the attachment unit 410 is configured to cooperate with the gravity of the smart terminal 200 to press and expel air trapped between the protective film 400 and the screen of the smart terminal 200.

In addition, in another case of this embodiment, when the attachment unit 410 is mounted on the second housing 620, the screen of the smart terminal 200 may face the second housing 620 (i.e., facing upward), and the attachment unit 410 mainly functions to fix the protective film 400. However, when the user pulls the release film 300 (the pull strip 500 may be included) out of the limiting frame 100 through the first opening 130 and the second opening 630, the attachment unit 410 may cooperate with the second stopping plate 150 to press and expel air trapped between the protective film 400 and the screen of the smart terminal 200.

Certainly, it should be understood that when the attachment unit 410 is mounted on both the first housing 610 and the second housing 620 simultaneously, better air expulsion effects can be achieved without restricting the orientation of the screen of the smart terminal 200, and use convenience may also be brought to the user.

It should be noted that although FIG. 10 only illustrates a side-opening connection relationship between the first housing 610 and the second housing 620 in the structure of the screen protector application box 600, those skilled in the art should understand that other connection relationships conforming to the structural features of this embodiment also fall within the protection scope of this embodiment. For example, a top-opening or bottom-opening connection also falls within the protection scope of this embodiment, and the principles are not repeated here.

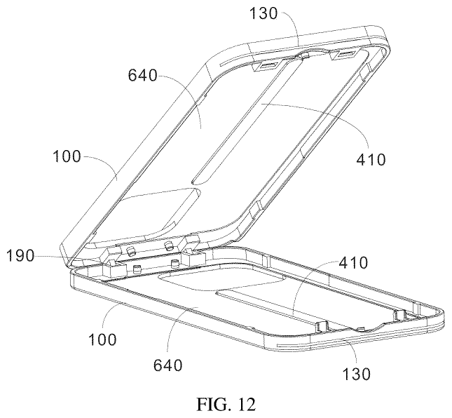

As shown in FIGS. 12 and 11, the present disclosure further provides a second configuration of the screen protector application box 600. Different from the above configuration, in this embodiment, the screen protector application box 600 is formed by connecting two limiting frames 100, bearing plates 640 are disposed between the limiting frames 100 and configured to bear the smart terminal 200, and the limiting frames 100 surround the bearing plates 640 to provide a limiting function. A connecting portion 190 is formed on the two limiting frames 100 at one end, and the connecting portion 190 causes the limiting frames 100 to be relatively opened and closed. The connection manner may be a shaft connection or a hinge connection, and is not limited herein. When the limiting frames 100 are closed, the limiting frames 100 cooperate with the bearing plates 640 to form a complete box. The first opening 130 is disposed at the other end of each of the limiting frames 100 away from the connecting portion 190. The other ends of the limiting frames 100 are detachably connected, e.g., by a snap-fit connection. The attachment unit 410 is disposed on the bearing plate 640.

It should be understood that the attachment unit 410 may be mounted on one of the bearing plates 640 or on both of the bearing plates 640 simultaneously. The same as the above principle, when the attachment unit 410 is mounted on the bottom bearing plate 640, the screen of the smart terminal 200 faces downward, and the release film 300 (the pull strip 500 may be included) and the protective film 400 are located between the smart terminal 200 and the attachment unit 410. In this case, the attachment unit 410 functions to fix the position of the protective film 400, and when the user pulls the release film 300 (the pull strip 500 may be included) out of the limiting frame 100 through the first opening 130, the attachment unit 410 is configured to cooperate with the gravity of the smart terminal 200 to press and expel air trapped between the protective film 400 and the screen of the smart terminal 200. When the attachment unit 410 is mounted on the top bearing plate 640, the screen of the smart terminal 200 faces upward, and the attachment unit 410 mainly functions to fix the protective film 400. However, when the user pulls the release film 300 (the pull strip 500 may be included) out of the limiting frame 100 through the first opening 130, the attachment unit 410 is configured to cooperate with the second stopping plate 150 to press and expel air trapped between the protective film 400 and the screen of the smart terminal 200. Certainly, the attachment unit 410 may be mounted on both of the bearing plates 640 simultaneously. In this embodiment, the screen of the smart terminal 200 may face either upward or downward. Compared with the first box configuration, the second box configuration forms a relatively enclosed complete box, and the limiting frames 100 can be mutually locked and fixed, thereby providing better wrapping and protection effects for the smart terminal 200.

Additionally, it should be noted that although FIGS. 11 and 12 only illustrate a side-opening connection relationship between the limiting frames 100 in the second structure of the screen protector application box 600, those skilled in the art should understand that other connection relationships conforming to the structural features of this embodiment also fall within the protection scope of this embodiment. For example, a top-opening or bottom-opening connection also falls within the protection scope of this embodiment, and the principles are not repeated here. It should also be reminded to the Examiner that both the first configuration and the second configuration of the screen protector application box 600 are applicable to the different limiting frames 100 described above, including but not limited to the above integrated frame or segmented frame (which may also include a plurality of segments or one of the segments).

The present disclosure is not limited to the details of the above exemplary embodiments, and the present disclosure may be implemented in other specific forms under the condition of not deviating from the spirit or basic features of the present disclosure. Therefore, from any point of view, the embodiments should be regarded as exemplary and non-limiting embodiments. The scope of the present disclosure is defined by the attached claims rather than the above description, and thus it is intended to include in the present disclosure all the changes that fall within the meaning and scope of the equivalent elements of the claims.

What is claimed is:

1. A screen protector application structure, comprising a limiting frame configured to cover a smart terminal, wherein the limiting frame has a first placement space for placing a release film and a protective film, and a second placement space for placing the smart terminal, a first opening configured for the release film to pass is formed between the first placement space and the second placement space, the limiting frame is provided with a first stopping plate located in the first placement space and configured to abut against the smart terminal, and a second stopping plate located on a side of the first placement space away from the second placement space and configured to stop the protective film from moving away from the smart terminal, a first avoidance surface is disposed at the first opening, the release film is located between the smart terminal and the first avoidance surface, the first avoidance surface is configured to allow the release film to be pulled out from the first opening, and a distance between a lowest point of the first avoidance surface and a screen of the smart terminal is smaller than a thickness of the protective film.

2. The screen protector application structure according to claim 1, wherein the first placement space is formed by the second stopping plate covering the first stopping plate configured in a rectangular frame shape, and the second stopping plate covers part of the first stopping plate; the second placement space is formed by superimposing the first stopping plate and a stopping sidewall, and the first stopping plate is exposed by the stopping sidewall; and the first avoidance surface is located on a side of the first opening close to the first stopping plate.

3. The screen protector application structure according to claim 2, wherein an outer wall of the limiting frame is further provided with a snap fastener comprising a first snap-fit portion and a second snap-fit portion, and the first snap-fit portion and the second snap-fit portion are disposed at opposite ends or along a periphery of the limiting frame, respectively; the first snap-fit portion has an arc-shaped transition structure, which is inwardly bendable to be fitted with a fillet contour of a rear cover of the smart terminal; and the second snap-fit portion extends toward a bottom port position of the smart terminal and has a recess segment or a tongue segment structure configured for snap-in connection and locking into the bottom port.

4. The screen protector application structure according to claim 3, wherein an inner side of the limiting frame is provided with avoidance recesses and structural reinforcement ribs.

5. The screen protector application structure according to claim 2, wherein a pre-positioning structure is disposed between the protective film and the limiting frame, and the pre-positioning structure comprises first protruding posts disposed on an inner wall of a front end edge of the limiting frame, and easily removable slots formed at an edge of the release film.

6. The screen protector application structure according to claim 5, wherein each of the easily removable slots is in communication with an expansion structure, the expansion structure is a hole, a perforation penetrating an edge of the release film, or a break line; when the expansion structure is configured as a hole structure, each of the first protruding posts is provided with an inclined guide portion, and when the expansion structure is configured as a break line, the expansion structure is a dashed-line structure formed on each of the easily removable slots by a pre-cutting or indentation process; and when a first pull portion is pulled and drawn out from the first opening, the expansion structure is configured to reduce resistance of the easily removable slots separating from the first protruding posts, such that the first pull portion is quickly drawn out through the first opening.

7. The screen protector application structure according to claim 5, wherein the pre-positioning structure further comprises an attachment unit, and the attachment unit is configured to fix the position of the protective film; and the attachment unit is a low-adhesion adhesive layer disposed on a surface of the protective film close to the limiting frame.

8. The screen protector application structure according to claim 6, wherein a pull strip is disposed between the release film and the smart terminal, the pull strip has a second pull portion, and the pull strip is adhered parallel to the release film.

9. The screen protector application structure according to claim 8, wherein a front end of the release film or the pull strip is provided with protruding strips extending forward, the easily removable slots and the protruding strips are correspondingly arranged, and the easily removable slots and the protruding strips are disposed at an edge of the pull strip and/or the release film and configured to form a snap-in connection cooperation with the first protruding posts.

10. The screen protector application structure according to any one of claims 1-9, wherein the screen protector application structure further comprises a screen protector application box configured to cooperate with the limiting frame, wherein the screen protector application box has a first housing, a second housing configured to cooperate with the first housing, and a second opening in communication with the first opening, the first housing is configured to bear the limiting frame, and the second housing covers and encloses the smart terminal within the limiting frame; and the release film and/or the pull strip extend/extends out of the limiting frame and the screen protector application box through the first opening and the second opening, and the attachment unit is mounted on the first housing and/or the second housing.

11. The screen protector application structure according to claim 1, wherein the screen protector application structure further comprises a screen protector application box configured to cooperate with the limiting frames, wherein the screen protector application box is formed by connecting two limiting frames, bearing plates are disposed between the limiting frames and configured to bear the smart terminal, and the limiting frames surround the bearing plates; a connecting portion is formed on the two limiting frames at one end, and the connecting portion allows the limiting frames to be relatively opened and closed; and the first opening is disposed at the other end of each of the limiting frames away from the connecting portion, the other ends of the limiting frames are detachably connected, and the attachment unit is disposed on the bearing plate.
